(19) United States
(12) Patent Application Publication
(10) Pub. No.: US 2009/0015516 A1
(43) Pub. Date: Jan. 15, 2009

(54) DISPLAY DEVICE AND METHOD OF DRIVING THE SAME

(75) Inventors: Hidehiko Shoji, Osaka (JP); Yutaka Yoshihama, Osaka (JP); Jumpei Hashiguchi, Kyoto (JP); Hironari Taniguchi, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/814,514

(22) PCT Filed: Jan. 18, 2006
(86) PCT No.: PCT/JP2006/300645

§ 371 Date: Jul. 23, 2007

(30) Foreign Application Priority Data
Jan. 25, 2005 (JP) 2005-017399

(51) Int. Cl. G09G 3/28; G06F 3/038

(52) U.S. Cl. 345/60; 345/214; 315/169.4

(57) ABSTRACT

A sub-field lighting rate measuring unit measures a lighting rate in a final sub-field. When the measured lighting rate exceeds a threshold value, a blank signal generator maintains a blank signal at a low level in a sustain time period in a sub-field. An output control circuit brings an output control signal into a low level on the basis of the blank signal. In this case, no data pulse is applied to an address electrode, so that there is no power consumed at the time of the rise and the fall of the data pulse.

### TECHNICAL FIELD

The present invention relates to a display device that displays an image by controlling discharges and a method of driving the same.

### BACKGROUND ART

Plasma display devices using PDPs (Plasma Display Panels) have the advantages that thinning and larger screens are possible. In the plasma display devices, images are displayed by utilizing light emission in inducing gas discharges.

(A) Discharge Cells in AC-Type PDP

FIG. 13 is a diagram for explaining a method of driving a discharge cell in an AC-type PDP. As shown in FIG. 13, surfaces of opposed electrodes 301 and 302 are respectively covered with dielectric layers 303 and 304 in the discharge cell in the AC-type PDP.

As shown in FIG. 13 (a), when a voltage lower than a discharge start voltage is applied between the electrodes 301 and 302, no discharges are induced.

As shown in FIG. 13 (b), when a pulse-shaped voltage (a write pulse) higher than the discharge start voltage is applied between the electrodes 301 and 302, discharges are induced. When discharges are induced, negative charges move toward the electrode 301 to be stored on a wall surface of the dielectric layer 303, and positive charges move toward the electrode 302 to be stored on a wall surface of the dielectric layer 304. The charges stored on each of the wall surfaces of the dielectric layers 303 and 304 are referred to as wall charges. A voltage induced by the wall charges is referred to as a wall voltage.

As shown in FIG. 13 (c), the negative wall charges are stored on the wall surface of the dielectric layer 303, and the positive wall charges are stored on the wall surface of the dielectric layer 304. In this case, the polarity of the wall voltage is opposite in direction to the polarity of an externally applied voltage. Therefore, an effective voltage in a discharge space decreases as the discharges advance, so that the discharges are automatically stopped.

As shown in FIG. 13 (d), when the polarity of the externally applied voltage is reversed, the polarity of the wall voltage is identical in direction to the polarity of the externally applied voltage, so that the effective voltage in the discharge space increases. When the effective voltage exceeds the discharge start voltage, discharges of opposite polarity are induced. Thus, the positive charges move toward the electrode 301 to neutralize the negative wall charges that have already been stored in the dielectric layer 303, and the negative charges move toward the electrode 302 to neutralize the positive wall charges that have already been stored in the dielectric layer 304.

As shown in FIG. 13 (e), the positive and negative wall charges are respectively stored on the wall surfaces of the dielectric layers 303 and 304. In this case, the polarity of the wall voltage is opposite in direction to the polarity of the externally applied voltage. Therefore, the effective voltage in the discharge space decreases as the discharges advance, so that the discharges are stopped.

Furthermore, when the polarity of the externally applied voltage is reversed, as shown in FIG. 13 (f), discharges of opposite polarity are induced, so that the negative charges move toward the electrodes 301 and the positive charges move toward the electrode 302, to return to the state shown in FIG. 13 (c).

After the discharges are thus started once by application of the write pulse higher than the discharge start voltage, the discharges can be sustained by reversing the polarity of an externally applied voltage (a sustain pulse) lower than the discharge start voltage by the function of the wall charges. To start discharges by applying a write pulse is referred to as address discharges, a time period during which address discharges are induced is referred to as an address time period, to sustain discharges by applying sustain pulses alternately reversed is referred to as sustain discharges, and a time period during which the sustain discharges are induced is referred to as a sustain time period.

(B) Configuration of PDP

FIG. 14 is a block diagram showing the basic configuration of a conventional AC-type plasma display device.

The plasma display device shown in FIG. 14 comprises an A/D converter (Analog-to-Digital Converter) 1, a video signal/sub-field corresponder 2, a sub-field processor 3, a data driver 4, a scan driver 5, a sustain driver 6, and a PDP (Plasma Display Panel) 7.

An analog video signal VD is inputted to the A/D converter 1. The A/D converter 1 converts the video signal VD into digital image data, and outputs the digital image data to the video signal/sub-field corresponder 2. In order to divide one field into a plurality of sub-fields for display, the video signal/sub-field corresponder 2 generates image data SP corresponding to each of the sub-fields from image data corresponding to one field, and outputs the image data SP to the sub-field processor 3.

The sub-field processor 3 generates a data driver driving control signal DS, a scan driver driving control signal CS, and a sustain driver driving control signal US from the image data SP for each sub-field, and respectively outputs the signals to the data driver 4, the scan driver 5, and the sustain driver 6.

The PDP 7 comprises a plurality of address electrodes (data electrodes) 11, a plurality of scan electrodes 12, and a plurality of sustain electrodes 13. The plurality of address electrodes 11 are arranged in the vertical direction on a screen, and the plurality of scan electrodes 12 and the plurality of sustain electrodes 13 are arranged in the horizontal direction on the screen. Further, the plurality of sustain electrodes 13 are commonly connected to one another.

A discharge cell 14 is formed at each of intersections of the address electrodes 11, the scan electrodes 12, and the sustain electrodes 13. Each of the discharge cells 14 composes a pixel on the screen.

The data driver 4 is connected to the plurality of address electrodes 11 in the PDP 7. The scan driver 5 contains a drive circuit provided for each of the scan electrodes 13, and each of the drive circuits is connected to the corresponding scan electrode 12 in the PDP 7. The sustain driver 6 is connected to the plurality of sustain electrodes 12 in the PDP 7.

The data driver 4 applies a data pulse to the corresponding address electrode 11 in the PDP 7 in response to the image data SP in an address time period in accordance with the data driver driving control signal DS. The scan driver 5 successively applies a write pulse to the plurality of scan electrodes 12 in the PDP 7 while shifting a shift pulse in a vertical scanning direction in the address time period in accordance with the scan driver driving control signal CS. Consequently, address discharges are induced in the corresponding discharge cell 14.

The scan driver 5 applies a periodical sustain pulse to the plurality of scan electrodes 12 in the PDP 7 in a sustain time period in accordance with the scan driver driving control signal CS. On the other hand, the sustain driver 6 simultaneously applies a sustain pulse whose phase is shifted by 180 degrees from the sustain pulse applied to the scan electrode 12 to the plurality of sustain electrodes 13 in the PDP 7 in the sustain time period in accordance with the sustain driver driving control signal US. Consequently, sustain discharges are induced in the corresponding discharge cell 14.

(C) Three-Electrode Surface Discharge Cell

FIG. 15 is a schematic sectional view of the discharge cell 14 shown in FIG. 14.

In the discharge cell 14 shown in FIG. 15, a scan electrode 12 and a sustain electrode 13 that are paired on a surface glass substrate 201 are formed in the horizontal direction on a screen, and the scan electrode 12 and the sustain electrode 13 are covered with a transparent dielectric layer 202 and a protective layer 203. On the other hand, an address electrode 11 is formed in the vertical direction on the screen on a back surface glass substrate 204 opposed to the surface glass substrate 201, and a transparent dielectric layer 205 is formed on the address electrode 11. A fluorescent member 206 is applied on the transparent dielectric layer 205.

In the discharge cell 14, address discharges are induced between the address electrode 11 and the scan electrode 12 by applying a write pulse between the address electrode 11 and the scan electrode 12, and sustain discharges are then induced between the scan electrode 12 and the sustain electrode 13 by applying periodical sustain pulses that are alternatively reversed between the scan electrode 12 and the sustain electrode 13.

(D) Gray Scale Expression Driving System

As a gray scale expression driving system in the AC-type PDP, an ADS (Address and Display-period Separated) system for separating an address time period during which address discharges are induced and a sustain time period during which sustain discharges are induced to discharge a discharge cell has been used (see Patent Document 1, for example).

FIG. 16 is a diagram for explaining the ADS system. In FIG. 16, the vertical axis indicates the scanning direction (vertical scanning direction) of scan electrodes from the first line to the m-th line, and the horizontal axis indicates time.

In the ADS system, one field ( 1/60 sec.=16.67 ms) is divided into a plurality of sub-fields on the time basis. When 256 gray scale expression is performed in units of eight bits, for example, one field is divided into eight sub-fields. Each of the sub-fields is divided into an address time period during which address discharges are induced for selecting a lighting cell and a sustain time period (a light emitting time period) during which sustain discharges for display are induced.

In the example shown in FIG. 16, one field is divided into four sub-fields SF1, SF2, SF3, and SF4 on the time basis. The sub-field SF1 is separated into an address time period AD1 and a sustain time period SUS1, the sub-field SF2 is separated into an address time period AD2 and a sustain time period SUS2, the sub-field SF3 is separated into an address time period AD3 and a sustain time period SUS3, and the sub-field SF4 is separated into an address time period AD4 and a sustain time period SUS4.

In the ADS system, the whole surface of the PDP from the first line to the m-th line in each of the sub-fields is scanned by address discharges, and sustain discharges are induced when the address discharges on the whole surface of the PDP are terminated.

In the ADS system, gray scale expression can be performed by selecting a sustain time period during which discharge cells on the PDP light up.

(E) Driving Voltage to Each Electrode

FIG. 17 is a timing chart showing an example of driving voltages respectively applied to the electrodes in the PDP 7 shown in FIG. 14.

In an initialization time period, an initial setup pulse Pset is simultaneously applied to the plurality of scan electrodes 12. Thereafter, in an address time period, a write pulse Pw is successively applied to the plurality of scan electrodes 12, and a data pulse Pda is applied to the selected address electrode 11 in synchronization with the write pulse Pw. Consequently, sequential address discharges are induced in the selected discharge cell 14 on the PDP 7.

In a sustain time period, a sustain pulse Psc is periodically applied to the plurality of scan electrodes 12, and a sustain pulse Psu is periodically applied to the sustain electrodes 13. The phase of the sustain pulse Psu is shifted by 180 degrees from the phase of the sustain pulse Psc. Consequently, sustain discharges are induced in the discharge cell 14 in which address discharges are induced in the address time period. As a result, the discharge cell 14 lights up, so that an image is displayed on the PDP 7.

Here, the data pulse Pda applied to each of the address electrodes 11 will be described in more detail.

FIG. 18 is a schematic view showing an example of a state where each of the discharge cells 14 in the sub-field SF1 lights up. FIG. 18 shows an example in which the states of the four discharge cells 14 provided on each of address electrodes 11a to 11d are “non-lighting”, “lighting”, “non-lighting”, and “lighting” in descending order. In FIG. 18, only a part of the PDP 7 shown in FIG. 14 is illustrated.

FIG. 19 is a timing chart showing an example of respective driving voltages applied to the address electrode 11a and the scan electrodes 12a to 12d in the address time period in the sub-field SF1 when the discharge cells 14 on the PDP 7 are in the state shown in FIG. 18.

In a case where the discharge cells 14 assume the state shown in FIG. 18 in the sub-field SF1, the data pulse Pda is applied to the address electrode 11a in synchronization with the write pulse Pw applied to the scan electrode 12b, and the data pulse Pda is applied thereto in synchronization with the write pulse Pw applied to the scan electrode 12d, as shown in FIG. 19. Thus, address discharges are induced in each of the discharge cells 14 on an intersection of the address electrode 11a and the scan electrode 12b and the discharge cell 14 on an intersection of the address electrode 11a and the scan electrode 12d in FIG. 18, and the discharge cells 14 light up in the sustain time period.

Similarly, the data pulse Pda is also applied to the address electrodes 11b to 11d in synchronization with the write pulse Pw applied to the scan electrodes 12b and 12d, which is not illustrated. Thus, address discharges are induced in each of the discharge cells 14 on the scan electrodes 12b and 12d, and the discharge cells 14 light up in the sustain time period.

Power is consumed at the time of the rise and the fall of the data pulse applied to each of the electrodes. Therefore, the power consumption is increased in proportion to the number of times of the rise and the number of times of the fall of the data pulse.

Therefore, various types of methods for reducing the power consumed at the time of the rise and the fall of the data pulse have been conventionally proposed.

For example, in a driving control device in a plasma display panel display device disclosed in Patent Document 2, driving pulses in a reset time period, an address time period, and a sustain time period are stopped for a sub-field in which no image bit information exists, which causes power consumption to be reduced.

In a method of driving a plasma display panel disclosed in Patent Document 3, the supply of driving pulses for a row electrode group in which no pixels light up in a predetermined sub-frame is stopped, which causes power consumption to be reduced.

In a plasma display panel driving device disclosed in Patent Document 4, respective driving operations in an initialization time period, a write time period, and a sustain time period are stopped for a sub-field in which there is no display data, which causes power consumption to be reduced.

Here, in a case where a plurality of discharge cells on each of address electrodes alternately enter a lighting state and a non-lighting state, as in the example shown in FIGS. 18 and 19, the number of times of the rise and the number of times of the fall of a data pulse are increased, so that the power consumption is particularly increased.

The methods disclosed in the above-mentioned Patent Documents 2 to 4 are effective because all driving pulses are stopped for a sub-field in which a discharge cell enters a non-lighting state. However, power consumed in a sub-field in which a discharge cell enters a lighting state cannot be reduced. In a case where discharge cells alternately enter a lighting state and a non-lighting state, as described above, the power consumption cannot be sufficiently reduced.

On the other hand, in a plasma display method disclosed in Patent Document 5, the power consumption of a data driver is estimated by monitoring display data in a transition pattern, to perform such driving as to reduce a sub-field when the estimated power consumption is high. In this case, the power consumption can be also reduced in a sub-field in which a discharge cell enters a non-lighting state.

[Patent Document 1] JP 2000-214823 A

[Patent Document 2] JP 10-177365 A

[Patent Document 3] JP 10-214058 A

[Patent Document 4] JP 2000-98972 A

[Patent Document 5] JP 2000-66638 A

### DISCLOSURE OF THE INVENTION

### Problems to be Solved by the Invention

In the method disclosed in the above-mentioned Patent Document 5, however, the power consumption of the data electrode driver is monitored in a display pattern, so that the power consumption cannot be reduced only in a particular display pattern. For example, there are a case where the power consumption can be reduced and a case where it cannot be reduced depending on a transition pattern for display even if the respective numbers of pixels displayed on one screen in the cases are the same. That is, in the method disclosed in the above-mentioned Patent Document 5, the power consumption cannot, in some cases, be sufficiently reduced depending on the display pattern.

### Means for Solving the Problems

An object of the present invention is to provide a display device capable of sufficiently reducing power consumption in various display patterns while preventing the image quality from being degraded and a method of driving the same.

(1)

A display device according to an aspect of the present invention is a display device that displays each of a plurality of gray levels in a combination of respective emission or non-emission states in a plurality of sub-fields, including a plurality of first electrodes arranged in a first direction; a plurality of second electrodes arranged in a second direction crossing the first direction; a plurality of third electrodes arranged in the second direction; a plurality of discharge cells respectively provided at intersections of the plurality of first electrodes, the plurality of second electrodes, and the plurality of third electrodes; detection means for detecting information based on the number of the discharge cells that simultaneously light up out of the plurality of discharge cells in the first sub-field out of the plurality of sub-fields; and potential holding means for holding the plurality of first electrodes at a constant potential in an address time period in the second sub-field out of the plurality of sub-fields depending on the information detected by the detection means, the second sub-field having a lower weight than the weight of the first sub-field.

In the display device, each of the plurality of gray levels is displayed in the combination of the respective emission or non-emission states in the plurality of sub-fields.

The plurality of first electrodes are arranged in the first direction, the plurality of second electrodes are arranged in the second direction crossing the first direction, the plurality of third electrodes are arranged in the second direction, and the plurality of discharge cells are respectively provided at the intersections of the plurality of first electrodes, the plurality of second electrodes, and the plurality of third electrodes.

The detection means detects the information based on the number of the discharge cells that simultaneously light up out of the plurality of discharge cells in the first sub-field. The potential holding means holds the first electrode at the constant potential in the address time period in the second sub-field depending on the detected information.

The second sub-field has the lower weight than the weight of the first sub-field. In this case, when the number of the discharge cells that light up in the first sub-field increases, the average luminance level of an image increases, which makes it difficult to determine the difference between luminance levels in the emission state and the non-emission state in the second sub-field.

According to the present invention, the potential of the first electrode is kept constant in the address time period in the second sub-field depending on the information detected by the detection means. Thus, the respective numbers of the rise and the fall of the pulse applied to the first electrode are reduced in the address time period in the second sub-field, which allows power consumed at the time of the rise and the fall of the pulse to be reduced.

On the other hand, the potential of the first electrode is kept constant in the address time period in the second sub-field, so that all the discharge cells enter the emission state or the non-emission state in the second sub-field irrespective of an image to be displayed. Therefore, an error occurs in the luminance level of the image. When the information based on the number of the discharge cells that simultaneously light up in the first sub-field satisfies predetermined conditions, however, the difference between the luminance levels in the emission state and the non-emission state in the second sub-field is difficult to determine, so that the image quality is hardly degraded. The results allow the power consumption of the display device to be sufficiently reduced while preventing the image quality from being degraded.

Since the potential of the first electrode is controlled on the basis of the number of the discharge cells that simultaneously light up in the first sub-field, the power consumption can be reduced irrespective of a display pattern. That is, the power consumption of the display device can be sufficiently reduced in various display patterns.

(2)

The information may be a lighting rate representing the ratio of the number of the discharge cells that simultaneously light up to the number of the plurality of discharge cells, and the potential holding means may hold the plurality of first electrodes at the constant potential in the address time period in the second sub-field out of the plurality of sub-fields when the lighting rate is not less than a predetermined value.

In this case, the lighting rate reaches not less than the predetermined value so that the average luminance level of an image increases. Consequently, the difference between the luminance levels in the emission state and the non-emission state of the discharge cell in the second sub-field is difficult to determine. This allows the power consumption to be reduced while preventing the image quality from being degraded.

(3)

The information may be the number of the discharge cells that simultaneously light up out of the plurality of discharge cells, and the potential holding means may hold the plurality of first electrodes at the constant potential in the address time period in the second sub-field out of the plurality of sub-fields when the number of the discharge cells that simultaneously light up is not less than a predetermined number.

In this case, the number of the discharge cells that simultaneously light up reaches not less than the predetermined number, so that the average luminance level of an image increases. Consequently, the difference between the luminance levels in the emission state and the non-emission state of the discharge cell in the second sub-field is difficult to determine. This allows the power consumption to be reduced while preventing the image quality from being degraded.

(4)

The constant potential may be a ground potential. In this case, no pulse is applied to the first electrode in the address time period in the second sub-field, which allows the power consumption to be sufficiently reduced.

(5)

The first sub-field may finally enter the emission state when the combinations of the respective emission or non-emission states in the plurality of sub-fields are arranged in the order in which the gray levels increase.

In this case, when the first sub-field enters the emission state, the gray level increases. When the information based on the number of the discharge cells that simultaneously light up in the first sub-field satisfies predetermined conditions, the average luminance level of an image increases, which makes it difficult to determine the difference between the luminance levels in the emission state and the non-emission state of the discharge cell in the second sub-field. This allows the power consumption to be reduced while preventing the image quality from being degraded.

(6)

The first sub-field may have the highest weight out of the plurality of sub-fields in one field. Note that the weight is based on the number of sustain pulses applied to the scan electrode or the sustain electrode in the sustain time period or the period of the sustain pulses.

In this case, when the first sub-field enters the emission state, the gray level increases. When the information based on the number of the discharge cells that simultaneously light up in the first sub-field satisfies predetermined conditions, the average luminance level of an image increases, which makes it difficult to determine the difference between the luminance levels in the emission state and the non-emission state of the discharge cell in the second sub-field. This allows the power consumption to be reduced while preventing the image quality from being degraded.

(7)

The plurality of sub-fields in each of the fields may be arranged on a time axis in ascending order of their weights. In this case, it is preferable that the first sub-field is a later sub-field.

(8)

Each of the fields may be divided into a plurality of ranges on a time axis, and the plurality of sub-fields may be arranged on the time axis in ascending order of their weights in each of the plurality of ranges.

In this case, it is possible to prevent a display flicker and a dynamic image pseudo-contour.

(9)

The second sub-field may have the lowest weight out of the plurality of sub-fields in one field.

In this case, the difference between the luminance levels in the emission state and the non-emission state in the second sub-field is difficult to determine, which can sufficiently prevent the image quality from being degraded.

(10)

A method of driving a display device according to another aspect of the present invention is a method of driving a display device comprising a plurality of first electrodes arranged in a first direction, a plurality of second electrodes arranged in a second direction crossing the first direction, a plurality of third electrodes arranged in the second direction, and a plurality of discharge cells respectively provided at intersections of the plurality of first electrodes, the plurality of second electrodes, and the plurality of third electrodes, comprising the steps of detecting information based on the number of the discharge cells that simultaneously light up out of the plurality of discharge cells in the first sub-field out of the plurality of sub-fields; and holding the plurality of first electrodes at a constant potential in an address time period in the second sub-field out of the plurality of sub-fields depending on the detected information, each of a plurality of gray levels being displayed in a combination of respective emission or non-emission states in the plurality of sub-fields, and the second sub-field having a lower weight than the weight of the first sub-field.

In the method of driving the display device, the information based on the number of the discharge cells that simultaneously light up out of the plurality of discharge cells in the first sub-field is detected. The first electrode is held at the constant potential in the address time period in the second sub-field depending on the detected information.

Each of the plurality of gray levels is displayed in the combination of the respective emission or non-emission states in the plurality of sub-fields. The second sub-field has a lower weight than the weight of the first sub-field. In this case, when the number of the discharge cells that light up in the first sub-field increases, the average luminance level of an image increases, which makes it difficult to determine the difference between the luminance levels in the emission state and the non-emission state in the second sub-field.

According to the present invention, the potential of the first electrode is kept constant in the address time period in the second sub-field depending on the detected information. Thus, the respective numbers of the rise and the fall of the pulse applied to the first electrode are reduced in the address time period in the second sub-field, which allows the power consumed at the time of the rise and the fall of the pulse to be reduced.

On the other hand, the potential of the first electrode is kept constant in the address time period in the second sub-field. Therefore, all the discharge cells enter the emission state or the non-emission state in the second sub-field irrespective of the image to be displayed, so that an error occurs in the luminance level of the image. When the information based on the number of the discharge cells that simultaneously light up in the first sub-field satisfies predetermined conditions, however, the image quality is hardly degraded. The results allow the power consumption of the display device to be sufficiently reduced while preventing the image quality from being degraded.

Since the potential of the first electrode is controlled on the basis of the number of the discharge cells that simultaneously light up in the first sub-field, which allows the power consumption to be reduced irrespective of a display pattern. That is, the power consumption of the display device can be sufficiently reduced in various display patterns.

### EFFECTS OF THE INVENTION

According to the present invention, the power consumption of a display device can be sufficiently reduced in various display patterns while preventing the image quality from being degraded.

### BRIEF DESCRIPTION OF THE DRAWINGS

FIG. 1 is a block diagram showing the configuration of a plasma display device according to a first embodiment of the present invention.

FIG. 2 is a block diagram showing the configuration of a data driver shown in FIG. 1.

FIG. 3 is a diagram for explaining the relationship among a driving control signal, a blank signal, an output control signal, and a data signal.

FIG. 4 is a diagram for explaining an ADS system applied to the plasma display device shown in FIG. 1.

FIG. 5 is a coding table showing an example of gray scale expression in the plasma display device according to the first embodiment.

FIG. 6 is a timing chart showing an example of signals and driving voltages in a sub-field in a case where a lighting rate in a final sub-field does not exceed a threshold value.

FIG. 7 is a timing chart showing an example of signals and driving voltages in a sub-field in a case where a lighting rate in a final sub-field exceeds a threshold value.

FIG. 8 is a block diagram showing the configuration of a plasma display device according to a second embodiment of the present invention.

FIG. 9 is a block diagram showing the configuration of a data driver shown in FIG. 8.

FIG. 10 is a diagram for explaining the relationship among a driving control signal, an output forcing signal, a blank signal, an output control signal, and a data signal.

FIG. 11 is a timing chart showing an example of signals and driving voltages in a sub-field in a case where a lighting rate in a final sub-field exceeds a threshold value.

FIG. 12 is a coding table showing another example of gray scale expression in a plasma display device.

FIG. 13 is a diagram for explaining a method of driving a discharge cell in an AC-type PDP.

FIG. 14 is a block diagram showing the basic configuration of a conventional AC-type plasma display device.

FIG. 15 is a schematic sectional view of a display cell shown in FIG. 14.

FIG. 16 is a diagram for explaining an ADS system.

FIG. 17 is a timing chart showing an example of a driving voltage applied to each of electrodes in the PDP shown in FIG. 14.

FIG. 18 is a schematic view showing an example of a state where each of discharge cells lights up in a sub-field.

FIG. 19 is a timing chart showing an example of a driving voltage applied to each of an address electrode and a scan electrode in an address time period in a sub-field when a discharge cell is in the state shown in FIG. 18.

### BEST MODE FOR CARRYING OUT THE INVENTION

The embodiments below describe a case where the present invention is applied to a plasma display device having a PDP (Plasma Display Panel) as an example of a display device.

### First Embodiment

(1) Overall Configuration of Plasma Display Device

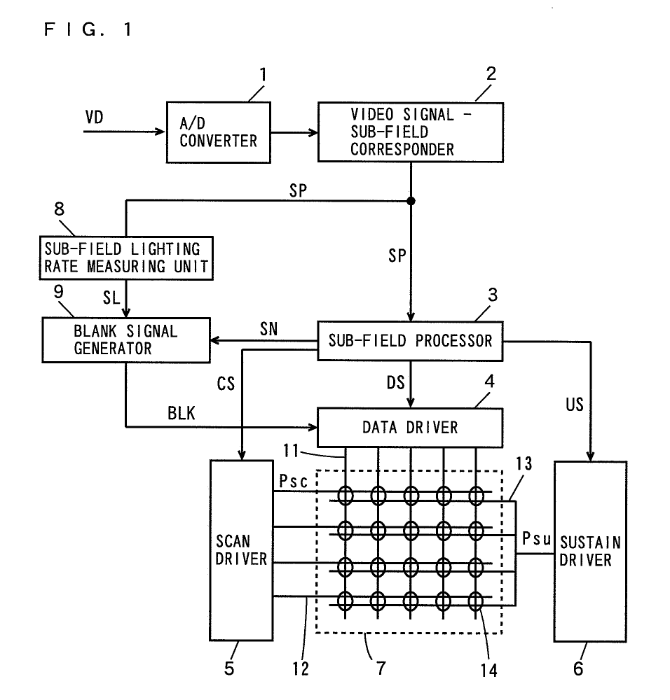

FIG. 1 is a block diagram showing the configuration of a plasma display device according to a first embodiment of the present invention.

A plasma display device shown in FIG. 1 comprises an A/D converter (Analog-to-Digital Converter) 1, a video signal/sub-field corresponder 2, a sub-field processor 3, a data driver 4, a scan driver 5, a sustain driver 6, a PDP (Plasma Display Panel) 7, a sub-field lighting rate measuring unit 8, and a blank signal generator 9.

An analog video signal VD is inputted to the A/D converter 1. The A/D converter 1 converts the analog video signal VD into digital image data, and outputs the digital image data to the video signal/sub-field corresponder 2.

Since the video signal/sub-field corresponder 2 divides one field into a plurality of sub-fields to perform display, it generates image data SP corresponding to each of the sub-fields from image data corresponding to one field, and outputs the generated image data SP to the sub-field processor 3 and the sub-field lighting rate measuring unit 8.

The sub-field lighting rate measuring unit 8 detects the respective lighting rates of discharge cells 14 simultaneously driven on the PDP 7 from the image data SP for each sub-field, and outputs the results of the detection to the blank signal generator 9 as a sub-field lighting rate signal SL.

Here, the lighting rate is expressed by the following equation if the minimum unit in a discharge space that can be independently controlled to a lighting/non-lighting state is referred to as a discharge cell:

Lighting rate (%)=(the number of discharge cells that simultaneously light up)/(the number of all discharge cells on PDP)×100

For example, the lighting rate is 100% when all the discharge cells 14 on the PDP 7 simultaneously light up, while being 0% when they do not induce discharges at all.

Specifically, the sub-field lighting rate measuring unit 8 separately calculates the lighting rates in all the sub-fields using video signal information, which is decomposed into one-bit information representing lighting/non-lighting of the discharge cell 14 for each of the sub-fields, produced by the video signal/sub-field corresponder 2, and outputs the results of the calculation to the blank signal generator 9 as a sub-field lighting rate signal SL.

For example, the sub-field lighting rate measuring unit 8 contains a counter, and finds for each of the sub-fields the total number of the discharge cells 14 that light up by increasing the value of the counter one at a time when the video signal information decomposed into the one-bit information representing lighting/non-lighting indicates lighting, and divides the total number of the discharge cells 14 by the number of all the discharge cells 14 on the PDP 7, to find the lighting rate.

The sub-field processor 3 generates a data driver driving control signal DS, a scan driver driving control signal CS, and a sustain driver driving control signal US from the image data SP for each of the sub-fields, and respectively outputs the signals to the data driver 4, the scan driver 5, and the sustain driver 6.

Furthermore, the sub-field processor 3 outputs a sub-field number SN to the blank signal generator 9.

The blank signal generator 9 generates a blank signal BLK on the basis of the sub-field lighting rate signal SL and the sub-field number SN, and outputs the generated blank signal BLK to the data driver 4.

The PDP 7 comprises a plurality of address electrodes (data electrodes) 11, a plurality of scan electrodes 12, and a plurality of sustain electrodes 13. The plurality of address electrodes 11 are arranged in the vertical direction on a screen, and the plurality of scan electrodes 12 and the plurality of sustain electrodes 13 are arranged in the horizontal direction on the screen. The plurality of sustain electrodes 13 are commonly connected to one another. A discharge cell 14 is formed at each of intersections of the address electrodes 11, the scan electrodes 12, and the sustain electrodes 13. Each of the discharge cells 14 composes a pixel on the screen.

The data driver 4 is connected to the plurality of address electrodes 11 in the PDP 7. The scan driver 5 contains a drive circuit provided for each of the scan electrodes 12, and each of the drive circuits is connected to the corresponding scan electrode 12 in the PDP 7. The sustain driver 6 is connected to the plurality of sustain electrodes 13 in the PDP 7.

The data driver 4 applies a write pulse to the corresponding address electrode 11 in the PDP 7 in response to the image data SP in an address time period in accordance with the data driver driving control signal DS and the blank signal BLK.

The scan driver 5 successively applies a write pulse to the plurality of scan electrodes 12 in the PDP 7 while shifting a shift pulse in a vertical scanning direction in the address time period in accordance with the scan driver driving control signal CS. This causes address discharges to be induced in the corresponding discharge cell 14.

The scan driver 5 applies a periodical sustain pulse Psc to the plurality of scan electrodes 12 in the PDP 7 in a sustain time period in accordance with the scan driver driving control signal CS.

On the other hand, the sustain driver 6 simultaneously applies a sustain pulse Psu whose phase is shifted by 180 degrees from the sustain pulse Psc in the scan electrode 12 to the plurality of sustain electrodes 13 in the PDP 7 in the sustain time period in accordance with the sustain driver driving control signal US. This causes sustain discharges to be induced in the corresponding discharge cell 14.

(2) Configuration of Data Driver

The data driver 4 shown in FIG. 1 will be then described in detail.

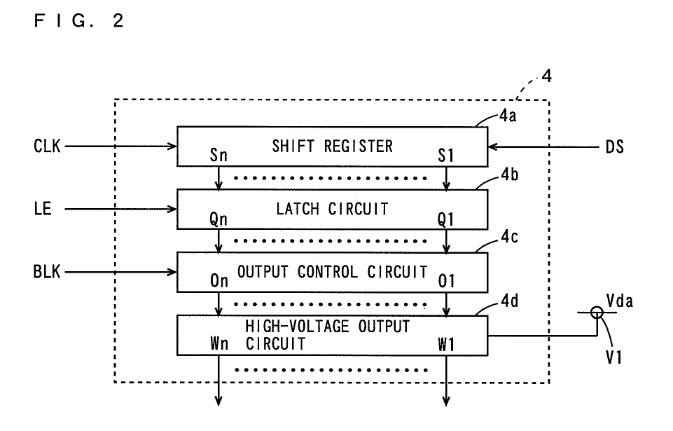

FIG. 2 is a block diagram showing the configuration of the data driver 4 shown in FIG. 1.

The data driver 4 shown in FIG. 2 comprises a shift register 4a, a latch circuit 4b, an output control circuit 4c, and a high-voltage output circuit 4d.

To the shift register 4a, a clock signal CLK is inputted from a clock generation circuit (not shown), and a data driver driving control signal DS is serially inputted from the sub-field processor 3 shown in FIG. 1. The shift register 4a converts the data driver driving control signal DS serially inputted into parallel driving control signals S1 to Sn and outputs the driving control signals S1 to Sn in response to the clock signal CLK. Note that n is an arbitrary integer.

To the latch circuit 4b, a latch enable signal LE is inputted from a latch enable signal generation circuit (not shown), and the driving control signals S1 to Sn are inputted from the shift register 4a. The latch circuit 4b respectively outputs the driving control signals S1 to Sn as driving control signals Q1 to Qn in response to the latch enable signal LE, and holds the driving control signals Q1 to Qn.

To the output control circuit 4c, a blank signal BLK is inputted from the blank signal generation circuit 9 shown in FIG. 1, and the driving control signals Q1 to Qn are inputted from the latch circuit 4b. On the basis of the blank signal BLK, the output control circuit 4c outputs the driving control signals Q1 to Qn as they are as output control signals O1 to On or outputs the output control signals O1 to On fixed to a low level.

A power supply terminal V1 receiving a voltage Vda is connected to the high-voltage output circuit 4d. The output control signals O1 to On are inputted to the high-voltage output circuit 4d from the output control circuit 4c. The high-voltage output circuit 4d respectively outputs data signals W1 to Wn having a data pulse at the voltage Vda to the plurality of address electrodes 11 shown in FIG. 1 in response to the output control signals O1 to On.

Here, the relationship among the one driving control signal Qi, the blank signal BLK, the one output control signal Oi, and the one data signal Wi will be described. Here, i is an arbitrary integer from 1 to n.

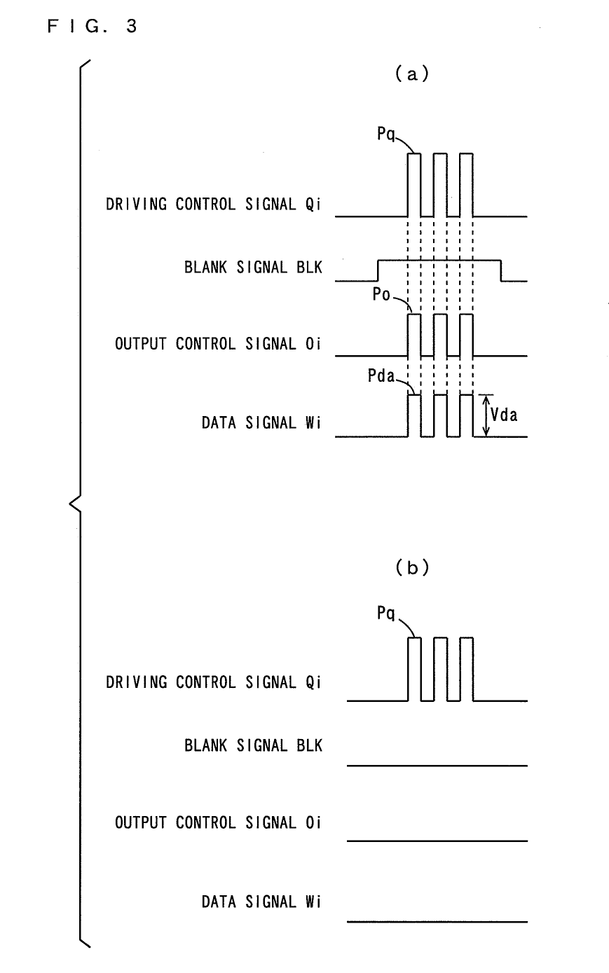

FIG. 3 is a diagram for explaining the relationship among the driving control signal Qi, the blank signal BLK, the output control signal Oi, and the data signal Wi.

As shown in FIG. 3 (a), when the blank signal BLK is at a high level, the output control circuit 4c outputs the driving control signal Qi as it is as the output control signal Oi. In this case, the output control signal Oi has a pulse Po corresponding to a pulse Pq of the driving control signal Qi. The high-voltage output circuit 4d outputs the data signal Wi having a data pulse Pda at the voltage Vda to the address electrode 11 in response to the pulse Po of the output control signal Oi.

On the other hand, as shown in FIG. 3 (b), when the blank signal BLK is at a low level, the output control circuit 4c fixes the output control signal Oi to a low level. In this case, the data signal Wi does not have the data pulse Pda, and is held at 0 V.

In the present embodiment, the level of the blank signal BLK is thus controlled, which makes it possible to choose whether or not the voltage Vda is applied to the address electrode 11.

(3) Description of Sub-Field

In the plasma display device shown in FIG. 1, an ADS (Address Display-Period Separation) system is used as a gray scale expression driving system.

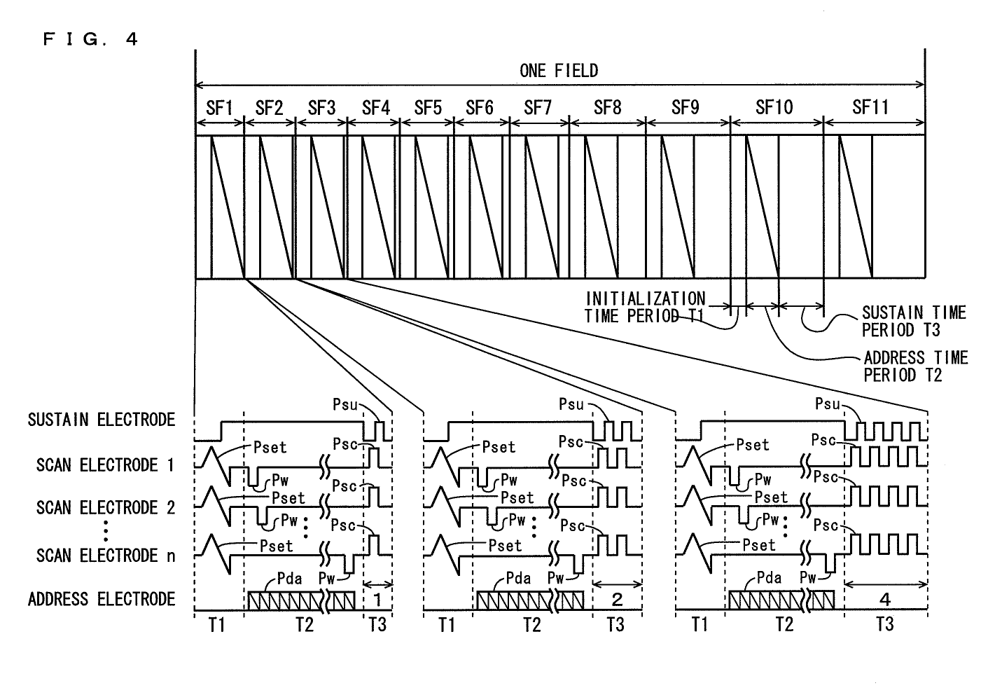

FIG. 4 is a diagram for explaining the ADS system applied to the plasma display device shown in FIG. 1. FIG. 4 schematically shows driving voltages respectively applied to one sustain electrode 13, n scan electrodes 12, and one address electrode 11. Although FIG. 4 shows an example of a pulse of positive polarity for inducing discharges at the time of the rise of a driving waveform, the basic operation is the same as the following even in the case of a pulse of negative polarity for inducing discharges at the time of the fall thereof.

In the ADS system, one field ( 1/60 sec.=16.67 ms) is divided into a plurality of sub-fields on the time basis. In the present embodiment, one field is divided into sub-fields SF1 to SF11.

Each of the sub-fields SF1 to SF11 is separated into an initialization time period T1, an address time period T2, and a sustain time period T3. The initialization operation of each of the sub-fields is performed in the initialization time period T1, address discharges for selecting the discharge cell 14 that lights up are induced in the address time period T2, and sustain discharges for display are induced in the sustain time period T3.

As shown in FIG. 4, in the initialization time period T1, an initialization setup pulse Pset is simultaneously applied to the plurality of scan electrodes 12. Thereafter, in the address time period T2, a write pulse Pw is successively applied to the plurality of scan electrodes 12, and a data pulse Pda is applied to the selected address electrode 11 in synchronization with the write pulse Pw. This causes sequential address discharges to be induced in the selected discharge cell 14 on the PDP 7 shown in FIG. 1. Note that the initialization setup pulse Pset in the initialization time period T1 need not be applied to all the sub-fields but may be applied to some of the sub-fields.

Then, in the sustain time period T3, a sustain pulse Psc is applied to the plurality of scan electrodes 12, and a sustain pulse Psu is applied to the sustain electrode 13. The phase of the sustain pulse Psu is shifted by 180 degrees from the phase of the sustain pulse Psc. This causes sustain discharges to be induced in the discharge cell 14 that has induced address discharges in the address time period T2.

Here, the number of times the sustain pulses Psu and Psc are applied differs depending on the sub-field. Consequently, the number of times of sustain discharges induced in the sustain time period T3 differs depending on the sub-field. This causes each of the sub-fields SF1 to SF11 to be weighted.

Note that the shift in the phase between the sustain pulse Psu and the sustain pulse Psc need not be 180 degrees. For example, respective parts of both the sustain pulses may be overlapped with each other on the time basis.

In the example shown in FIG. 4, in the sub-field SF1, the sustain pulse Psu is applied once to the sustain electrode 13, the sustain pulse Psc is applied once to the scan electrode 12, and the selected discharge cell 14 induces sustain discharges twice in the address time period T2. In the sub-field SF2, the sustain pulse Psu is applied twice to the sustain electrode 13, the sustain pulse Psc is applied twice to the scan electrode 12, and the selected discharge cell 14 induces sustain discharges four times in the address time period T2. In the sub-field SF3, the sustain pulse Psu is applied four times to the sustain electrode 13, the sustain pulse Psc is applied four times to the scan electrode 12, and the selected discharge cell 14 induces sustain discharges eight times in the address time period T2. In the example shown in FIG. 4, the weights of the sub-fields SF1 to SF3 are respectively taken as 1, 2, and 4.

Each of the gray levels can be displayed by combining respective emission or non-emission states in the sub-fields SF1 to SF11. The number of divisions into the sub-fields, the weight of each of the sub-fields, and the like are not particularly limited to those in the above-mentioned example, but can be subjected to various changes. Further, a time interval between the sub-fields need not be always constant but can be changed depending on the number of divisions into the sub-fields or the weight of each of the sub-fields.

A specific example of the sub-field used in the present embodiment will be then described.

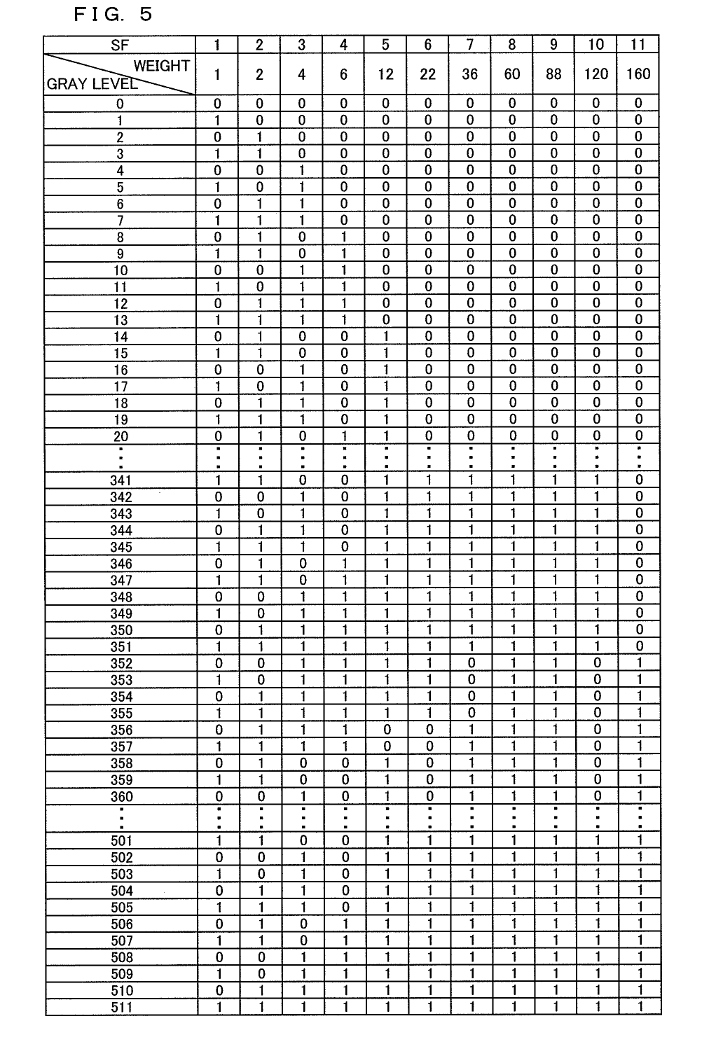

FIG. 5 is a coding table showing an example of gray scale expression in the plasma display device according to the present embodiment. Note that “1” to “11” in the first row in FIG. 5 respectively indicate sub-fields SF1 to SF11, and in the second row respectively indicate the weights of the sub-fields SF1 to SF11. Further, figures in the leftmost column respectively indicate gray levels. In FIG. 5, in sub-field columns at each of the gray levels, “1” indicates the sub-field that enters the emission state, and “0” indicates the sub-field that does not enter the emission state.

As shown in FIG. 5, the weights of the sub-fields SF1 to SF11 are respectively 1, 2, 4, 6, 12, 22, 36, 60, 88, 120 and 160, and the weight of each of the sub-fields corresponds to the number of times of sustain discharges in the discharge cell 14 in the sustain time period T3 in the sub-field. In the example shown in FIG. 5, each of the gray levels 0 to 511 is displayed by combining the respective emission or non-emission states in the sub-fields SF1 to SF11.

In order to display the gray level 7, for example, sustain discharges (light emission) are induced in each of the respective sustain time periods P3 in the sub-fields SF1, SF2, and SF3.

(4) Driving Control Based on Lighting Rate

A driving voltage applied to the address electrode 11 will be then described in detail.

In the coding table shown in FIG. 5, when the gray levels 0 to 511 are successively displayed by combining the respective emission or non-emission states in the sub-fields SF1 to SF11, the sub-field SF3 does not enter the emission state until the gray level 4 is displayed, and the sub-field SF5 does not enter the emission state until the gray level 14 is displayed, for example.

Similarly, each of the sub-fields SF1 to SF10 does not enter the emission state until any one of the gray levels 1 to 351 is displayed, and the sub-field SF11 does not enter the emission state until the gray level 352 is displayed. That is, when combinations of emission and non-emission states in each of the sub-fields are arranged in the order in which the gray levels increase in the coding table shown in FIG. 5, the sub-field SF11 finally enters the emission state. The sub-field that finally enters the emission state when the combinations of emission and non-emission states in each of the sub-fields are arranged in the order in which the gray levels increase is referred to as a final sub-field LSF.

Note that the final sub-field LSF need not necessarily be positioned last on the time basis within one field.

As described in the foregoing, the lighting rate in each of the sub-fields is measured by the sub-field lighting rate measuring unit 8 shown in FIG. 1. In the present embodiment, when the lighting rate in the final sub-field LSF (sub-field SF11) measured by the sub-field lighting rate measuring unit 8 exceeds a previously set threshold value, the data pulse Pda is not applied to the address electrode 11 in the sub-field SF1 having the lowest weight in the same field. In this case, although the discharge cell 14 does not light up in the sub-field SF1, the average luminance level of an image (PDP7) is high when the lighting rate in the final sub-field LSF is high. Therefore, a viewer hardly feels the degradation of the image quality. That is, the adjustment of the threshold value of the lighting rate makes it possible to prevent the image quality from being degraded because the sub-field SF1 does not enter the emission state. The threshold value of the lighting rate is 40%, for example. Description is now made of the driving method using the drawings.

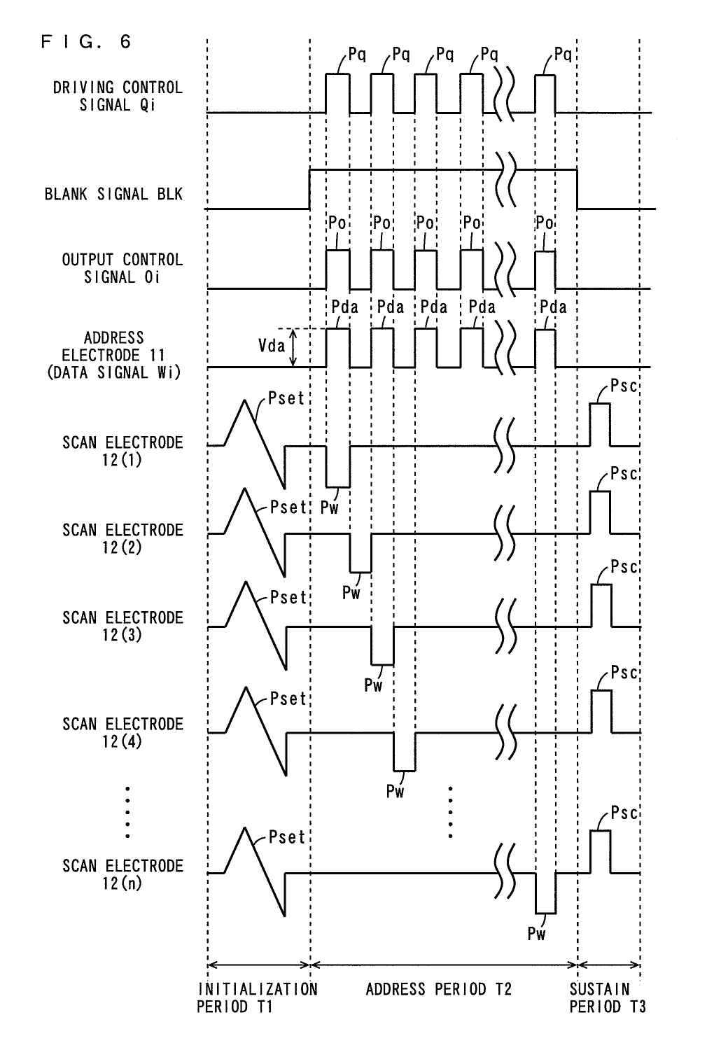

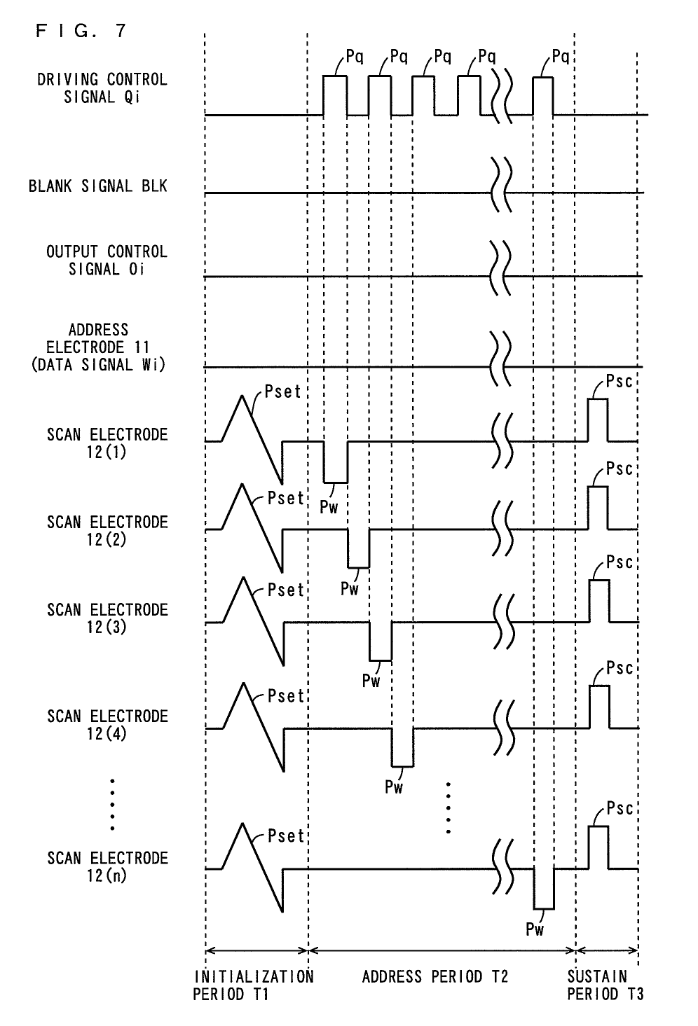

FIG. 6 is a timing chart showing an example of signals and driving voltages in the sub-field SF1 in a case where the lighting rate in the final sub-field LSF does not exceed the threshold value, and FIG. 7 is a timing chart showing an example of signals and driving voltages in the sub-field SF1 in a case where the lighting rate in the final sub-field LSF exceeds the threshold value.

FIGS. 6 and 7 show an example of a driving voltage of one of the plurality of address electrodes 11. Further, the plurality of scan electrodes 12 are respectively assigned reference numerals 12 (1) to 12 (n) in order to distinguish their driving voltages.

In the example shown in FIGS. 6 and 7, description is made of a case where a driving control signal Qi having a plurality of pulses Pq is outputted from the latch circuit 4b shown in FIG. 2 in an address time period T2. In this example, the plurality of pulses Pq are respectively synchronized with write pulses Pw applied to the alternate scan electrodes 12 (1), 12 (3), . . . , 12 (n).

Here, when the lighting rate in the final sub-field LSF in the same field that has been measured by the sub-field lighting rate measuring unit 8 shown in FIG. 1 does not exceed a threshold value, the blank signal generator 9 (see FIG. 1) brings a blank signal BLK into a high level in the address time period T2, as shown in FIG. 6. At this time, the output control circuit 4c (see FIG. 3) outputs the driving control signal Qi as it is as an output control signal Oi. In this case, the output control signal Oi has pulses Po respectively corresponding to the pulses Pq of the driving control signal Qi. Further, the high-voltage output circuit 4d (see FIG. 3) outputs a data signal Wi having data pulses Pda at a voltage Vda to the address electrode 11 in response to the pulses Po of the output control signal Oi. Thus, address discharges are induced in the alternate scan electrodes 12 (1), 12 (3), . . . , 12 (n), and the discharge cell 14 induces sustain discharges in a sustain time period T3.

On the other hand, in a case where the lighting rate in the final sub-field LSF in the same field exceeds the threshold value, the blank signal generator 9 (see FIG. 1) maintains the blank signal BLK at a low level in the address time period T2, as shown in FIG. 7. At this time, the output control circuit 4c (see FIG. 3) fixes the output control signal Oi to a low level in the address time period T2. In this case, the data signal Wi does not have the data pulses Pda, and is held at 0 V. Thus, there is no power to be consumed at the rise and the fall of the data pulse Pda in the address electrode 11, which allows the power consumption of the plasma display device to be reduced. In this case, the sub-field SF1 does not enter the emission state in all the discharge cells 14. However, the average luminance level of an image is high, so that a viewer hardly feels the degradation of the image quality.

In the present embodiment, when the lighting rate in the final sub-field LSF exceeds the threshold value, the data pulses Pda are not thus applied to the address electrode 11 in the sub-field SF1 having the lowest weight in the same field. This allows the power consumption of the plasma display device to be sufficiently reduced while preventing the image quality from being degraded.

Since the application of the data pulses Pda to the address electrode 11 is controlled on the basis of the lighting rate, the power consumption of the plasma display device can be reduced irrespective of a display pattern. That is, the power consumption of the plasma display device can be sufficiently reduced in various display patterns.

In a case where the lighting rate in the final sub-field LSF exceeds the threshold value, the sub-field in which the data pulses Pda are not applied is not limited to the sub-field SF1. For example, the data pulses Pda need not be applied in the sub-fields SF1 and SF2, and the data pulses Pda need not be applied in the sub-fields SF1 to SF3. In this case, the threshold value is also adjusted, which allows the power consumption of the plasma display device to be sufficiently reduced in various display patterns while preventing the image from being degraded.

### Second Embodiment

A plasma display device according to a second embodiment differs from the plasma display device according to the first embodiment in the following points.

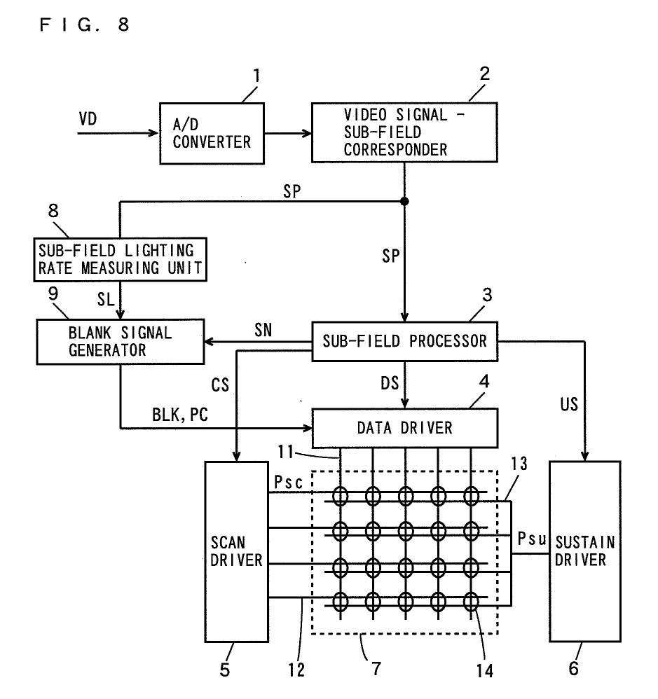

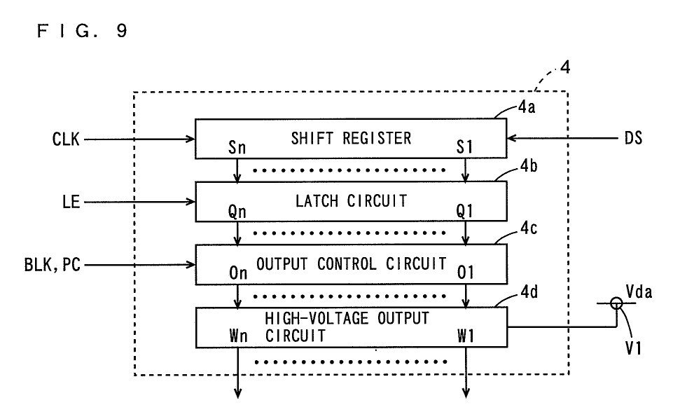

FIG. 8 is a block diagram showing the configuration of the plasma display device according to the second embodiment of the present invention, and FIG. 9 is a block diagram showing the configuration of a data driver 4 shown in FIG. 8.

As shown in FIG. 8, in the present embodiment, a blank signal generator 9 generates a blank signal BLK and an output forcing signal PC on the basis of a sub-field lighting rate signal SL and a sub-field number SN, and outputs the generated signals to a data driver 4.

As shown in FIG. 9, the blank signal BLK and the output forcing signal PC are inputted to an output control circuit 4c in the data driver 4.

The output control circuit 4c outputs driving control signals Q1 to Qn as they are as output control signals O1 to On, as output control signals O1 to On fixed to a low level, or as output control signals O1 to On fixed to a high level on the basis of the blank signal BLK and the output forcing signal PC.

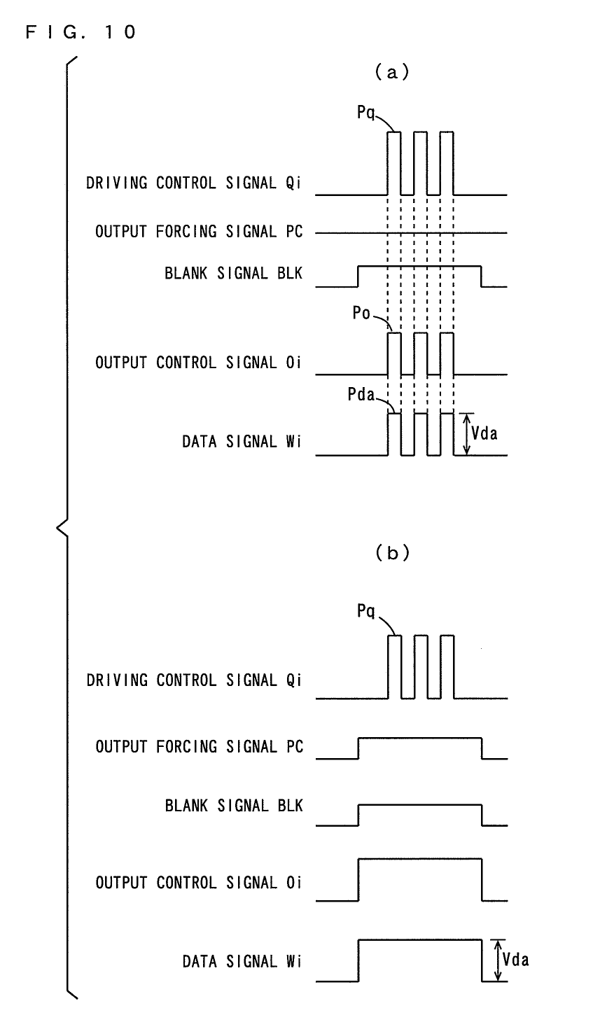

FIG. 10 is a diagram showing the relationship among the driving control signal Qi, the output forcing signal PC, the blank signal BLK, the output control signal Oi, and a data signal Wi.

As shown in FIG. 10 (a), when the output forcing signal PC is at a low level and the blank signal BLK is at a high level, the output control circuit 4c outputs the driving control signal Qi as it is as the output control signal Oi. In this case, the output control signal Oi has a pulse Po corresponding to a pulse Pq of the driving control signal Qi. The high-voltage output circuit 4d outputs the data signal Wi having a data pulse Pda at a voltage Vda to an address electrode 11 in response to the pulse Po of the output control signal Oi.

On the other hand, as shown in FIG. 10 (b), when the output forcing signal PC is at a high level and the blank signal BLK is at a high level, the output control circuit 4c fixes the output control signal Oi to a high level. In this case, the data signal Wi is held at the voltage Vda.

When the blank signal BLK is at a low level, the data signal Wi is held at 0 V irrespective of the level of the output forcing signal PC, which is not illustrated.

In the present embodiment, the respective levels of the output forcing signal PC and the blank signal BLK are thus controlled, which makes it possible to choose whether or not the voltage Vda is applied to the address electrode 11.

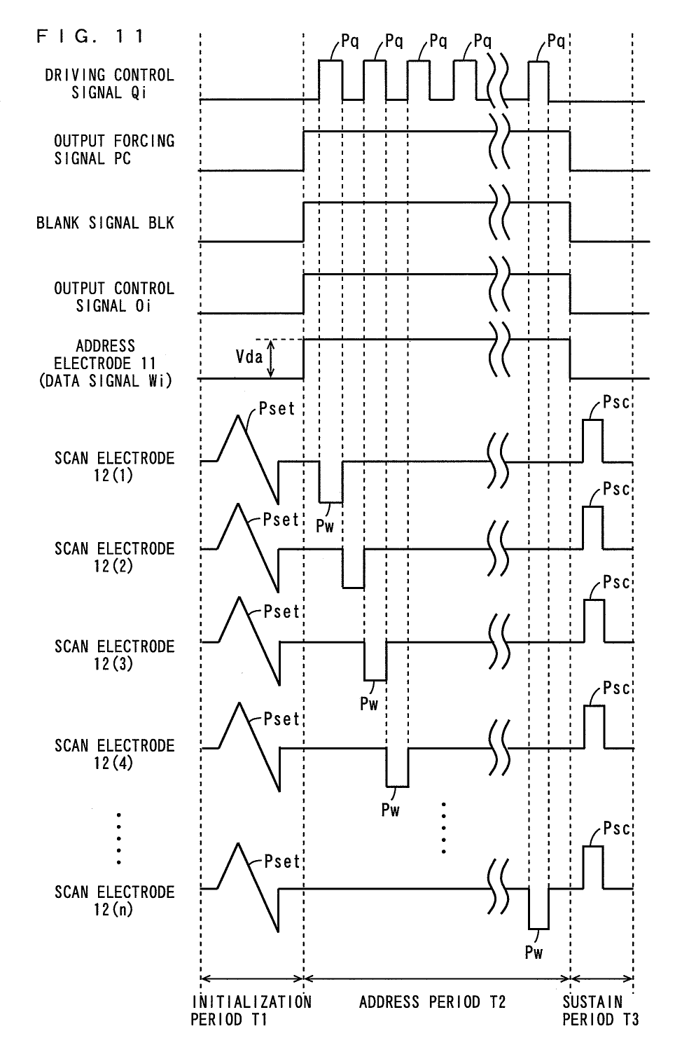

FIG. 11 is a timing chart showing an example of signals and driving voltages in a sub-field SF1 in a case where the lighting rate in a final sub-field LSF exceeds a threshold value.

In the present embodiment, when the output forcing signal PC and the blank signal BLK are at a high level in an address time period T2, the output control circuit 4c (see FIG. 10) fixes the output control signal Oi to a high level in the address time period T2. At this time, the high voltage output circuit 4d (see FIG. 10) fixes the data signal Wi to the voltage Vda in the address time period T2 and outputs the data signal Wi to the address electrode 11. In this case, the respective numbers of times of the rise and the fall of the data pulse Pda are one in the address time period T2, power consumed at the time of the rise and the fall of the data pulse Pda can be reduced. In the present embodiment, the sub-field SF1 enters an emission state in all discharge cells 14 when the lighting rate in the final sub-field LSF exceeds the threshold value. However, the average luminance level of an image is high, so that a viewer hardly feels the degradation of the image quality.

In the present embodiment, when the lighting rate in the final sub-field LSF exceeds the threshold value, the data pulse Pda for sustaining the voltage Vda is applied in the address time period T2 in the sub-field SF1 having the lowest weight in the same field. This allows the power consumption of the plasma display to be sufficiently reduced while preventing the image quality from being degraded.

Since the application of the data pulse Pda to the address electrode 11 is controlled on the basis of the lighting rate, the power consumption of the plasma display device can be reduced irrespective of a display pattern. That is, the power consumption of the plasma display device can be sufficiently reduced in various display patterns.

### Another Embodiment

Although in the above-mentioned embodiments, the sub-fields are arranged such that the weights thereof successively increase on the time axis of light emission, the sub-fields may be arranged as follows.

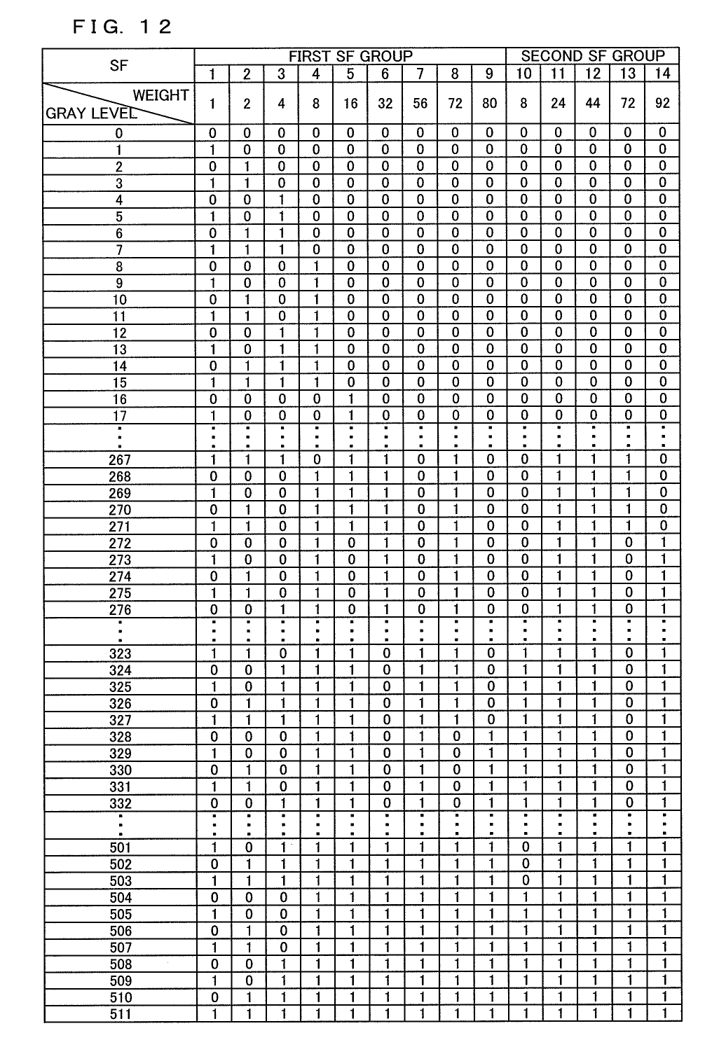

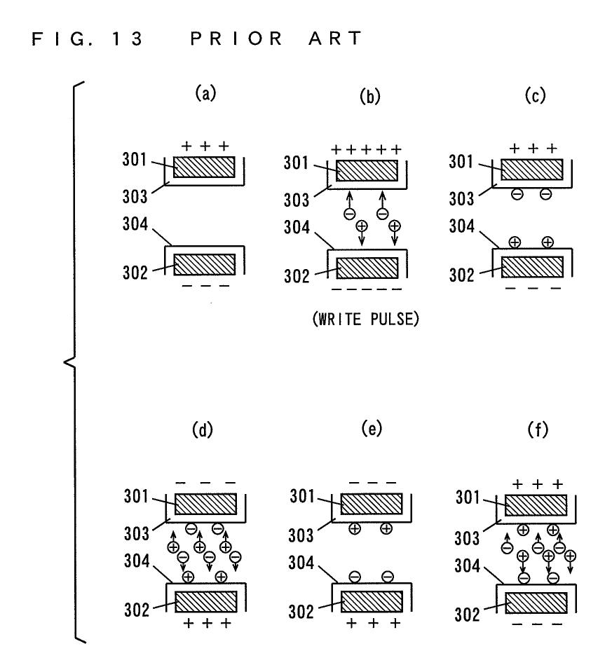

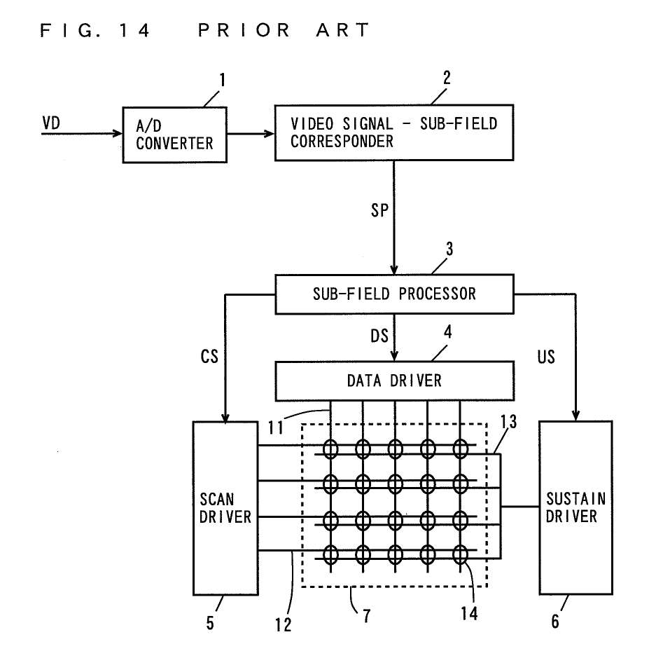

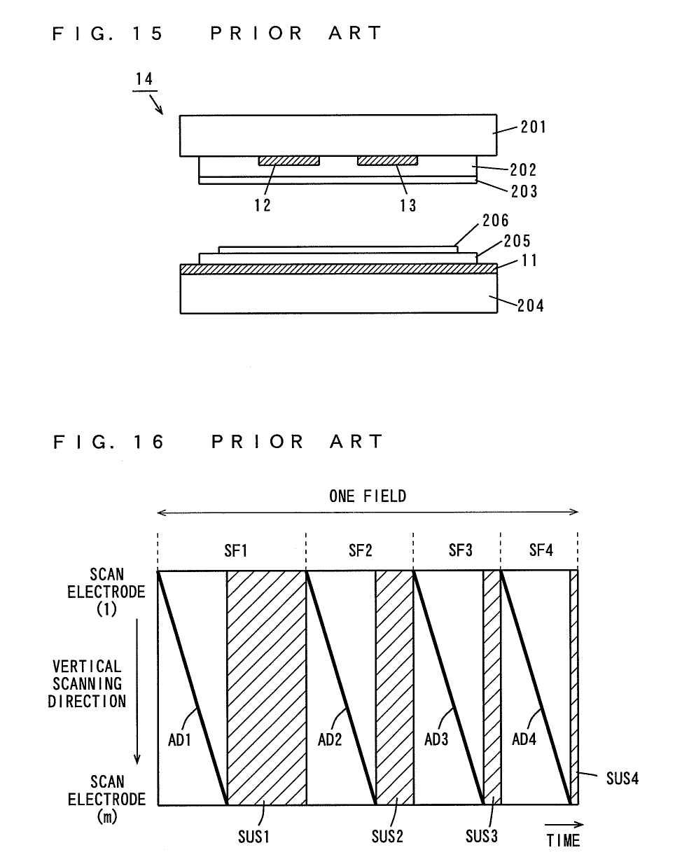

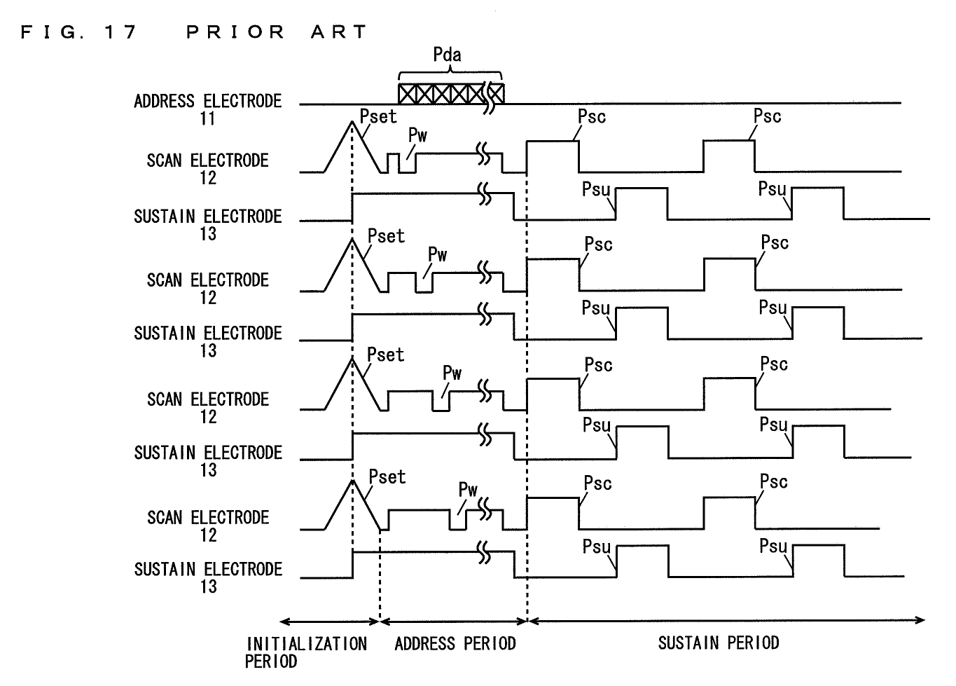

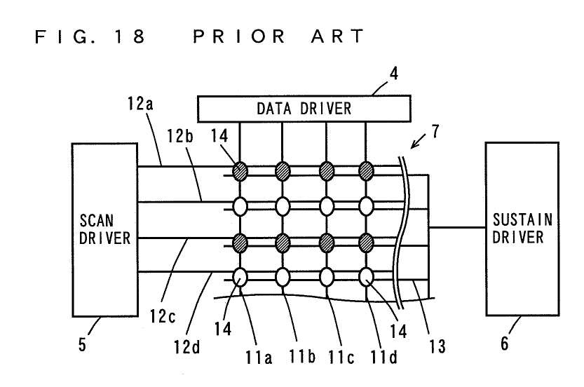

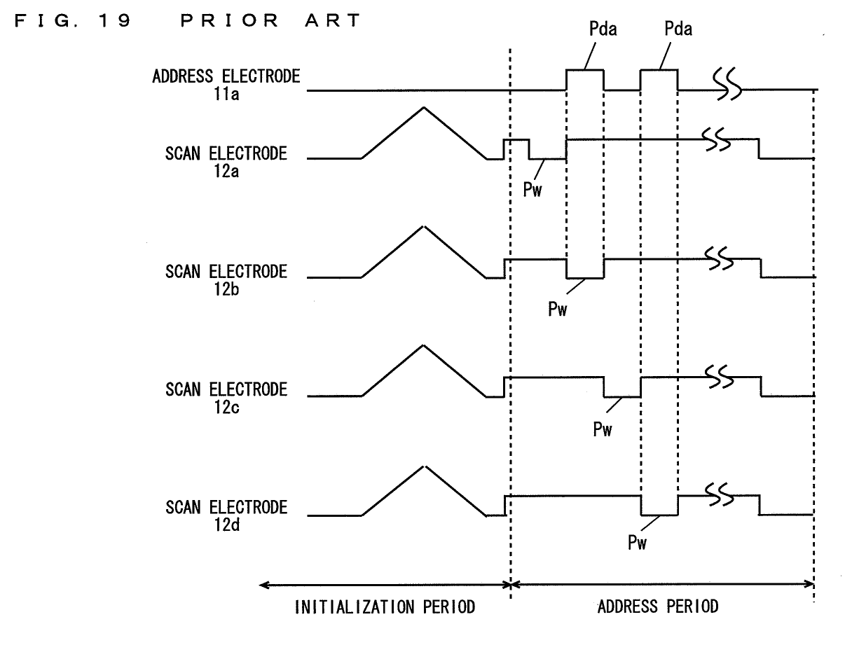

FIG. 12 is a coding table showing another example of gray scale expression in a plasma display device. In the coding table shown in FIG. 12, sub-fields can be partitioned into a first sub-field group comprising sub-fields SF1 to SF9 and a second sub-field group comprising sub-fields SF10 to SF14.

In the first sub-field group, the sub-fields SF1 to SF9 are arranged such that the weights thereof successively increase on the time axis. Similarly, in the second sub-field group, the sub-fields SF10 to SF14 are arranged such that the weights thereof successively increase on the time axis. In the example shown in FIG. 12, the sub-fields in the second sub-field group enter an emission state subsequently to the sub-fields in the first sub-field group.

When one field is thus divided into a plurality of sub-field groups on the time axis and a plurality of sub-fields are arranged such that the weights thereof increase in each of the sub-field groups, a display flicker and a dynamic image pseudo-contour can be prevented.

In the coding table shown in FIG. 12, when the combinations of emission and non-emission states in each of the sub-fields are arranged in the order in which the gray levels increase, the sub-field SF9 that does not enter the emission state when the gray level 327 and the preceding gray levels are displayed finally enters the emission state at the gray level 328. That is, in the coding table shown in FIG. 12, the sub-field SF9 becomes the final sub-field LSF.

Although in the present embodiment, the data pulse Pda applied to the address electrode 11 is controlled on the basis of the lighting rate in the final sub-field LSF, the data pulses Pda may be controlled on the basis of the number of times of lighting in the final sub-field LSF. In this case, the same effect as that in the foregoing case can be obtained by setting a threshold value of the number of times of lighting.

(Correspondence Between Various Constituent Elements in the Claims and Units in the Embodiments)

In the embodiments described above, the address electrode 11 corresponds to a first electrode, the scan electrode 12 corresponds to a second electrode, the sustain electrode 13 corresponds to a third electrode, the sub-field lighting rate measuring unit 8 corresponds to detection means, the final sub-field LSF corresponds to a first sub-field, the sub-field SF1 corresponds to a second sub-field, and the first sub-field group and the second sub-field group correspond to a plurality of ranges.

### INDUSTRIAL APPLICABILITY

The present invention is applicable to display of various videos.

1. A display device that displays each of a plurality of gray levels in a combination of respective emission or non-emission states in a plurality of sub-fields, comprising
a plurality of first electrodes arranged in a first direction;
a plurality of second electrodes arranged in a second direction crossing said first direction;
a plurality of third electrodes arranged in said second direction;
a plurality of discharge cells respectively provided at intersections of said plurality of first electrodes, said plurality of second electrodes, and said plurality of third electrodes;
detection means for detecting information based on the number of the discharge cells that simultaneously light up out of the plurality of discharge cells in the first sub-field out of said plurality of sub-fields; and
potential holding means for holding said plurality of first electrodes at a constant potential in an address time period in the second sub-field out of said plurality of sub-fields depending on the information detected by said detection means,
said second sub-field having a lower weight than the weight of said first sub-field.

2. The display device according to claim 1, wherein
said information is a lighting rate representing the ratio of the number of the discharge cells that simultaneously light up to the number of said plurality of discharge cells, and
said potential holding means holds said plurality of first electrodes at the constant potential in the address time period in the second sub-field out of said plurality of sub-fields when said lighting rate is not less than a predetermined value.

3. The display device according to claim 1, wherein
said information is the number of the discharge cells that simultaneously light up out of said plurality of discharge cells, and
said potential holding means holds said plurality of first electrodes at the constant potential in the address time period in the second sub-field out of said plurality of sub-fields when the number of the discharge cells that simultaneously light up is not less than a predetermined number.

4. The display device according to claim 1, wherein said constant potential is a ground potential.

5. The display device according to claim 1, wherein said first sub-field finally enters the emission state when the combinations of the respective emission or non-emission states in said plurality of sub-fields are arranged in the order in which the gray levels increase.

6. The display device according to claim 1, wherein said first sub-field has the highest weight out of the plurality of sub-fields in one field.

7. The display device according to claim 1, wherein the plurality of sub-fields in each of the fields are arranged on a time axis in ascending order of their weights.

8. The display device according to claim 1, wherein each of the fields is divided into a plurality of ranges on a time axis, and the plurality of sub-fields are arranged on the time axis in ascending order of their weights in each of said plurality of ranges.

9. The display device according to claim 1, wherein said second sub-field has the lowest weight out of the plurality of sub-fields in one field.

10. A method of driving a display device comprising a plurality of first electrodes arranged in a first direction, a plurality of second electrodes arranged in a second direction crossing said first direction, a plurality of third electrodes arranged in said second direction, and a plurality of discharge cells respectively provided at intersections of said plurality of first electrodes, said plurality of second electrodes, and said plurality of third electrodes, comprising the steps of:
detecting information based on the number of the discharge cells that simultaneously light up out of the plurality of discharge cells in the first sub-field out of said plurality of sub-fields; and
holding said plurality of first electrodes at a constant potential in an address time period in the second sub-field out of said plurality of sub-fields depending on said detected information,
each of a plurality of gray levels being displayed in a combination of respective emission or non-emission states in said plurality of sub-fields, and
said second sub-field having a lower weight than the weight of said first sub-field.
